(19) United States
(12) Patent Application Publication
(10) Pub. No.: US 2016/0161642 A1
(43) Pub. Date: Jun. 9, 2016

(54) HARD-COAT INFUSED POLYCARBONATE HEADLAMP LENS AND RELATED METHOD

(71) Applicant: FORD GLOBAL TECHNOLOGIES, LLC, Dearborn, MI (US)

(72) Inventors: Paul Kenneth Dellock, Northville, MI (US); Talat Karmo, Waterford, MI (US); Stuart C. Salter, White Lake, MI (US); Arsen Terjimanian, Troy, MI (US); Joseph Myszka, Livonia, MI (US)

(21) Appl. No.: 14/832,454

(22) Filed: Aug. 21, 2015

Related U.S. Application Data
(60) Provisional application No. 62/086,965, filed on Dec. 3, 2014.

(51) Int. Cl. G02B 1/14; F21S 8/10; B29D 11/00

(52) U.S. Cl. CPC G02B 1/14; B29D 11/00009; B29D 11/00865; F21S 48/1225; B29K 2069/00

(57) ABSTRACT

A headlamp lens includes a polycarbonate substrate and an infused protective skin covering on at least one surface of the polycarbonate substrate.

This application claims the benefit of U.S. provisional patent application Ser. No. 62/086,965 filed on 3 Dec. 2014, the full disclosure of which is incorporated herein by reference.

### TECHNICAL FIELD

This document relates generally to the vehicle equipment field and, more particularly, to a hard-coat infused polycarbonate lens that is less expensive to produce and provides better performance including, particularly, better resistance to UV degradation over time so as to remain clear for the free passage of light for the life of the vehicle.

### BACKGROUND

Currently, headlamp lenses are molded from optically clear polycarbonate. In order to protect the headlamp lenses from both abrasion and ultraviolet (UV) weathering degradation, a clear silica hard-coat and anti-UV additives are applied to the forward surface of the headlamp. Silica hard-coated polycarbonate headlamp lenses provide excellent resistance to scratches and excellent impact performance. However, silica hard-coated polycarbonate headlamp lenses suffer a number of drawbacks.

More specifically, the silica hard-coating process is very expensive and typically requires large facility expense in order to implement. Further, exposure to UV radiation from the rays of the sun attacks both the coating and the lens base polycarbonate substrate. Current state-of-the-art UV protection lasts up to 3000 hours of accelerated weathering. However, it should be appreciated that many vehicles including, for example, those in the Sun Belt areas of the United States are exposed to substantial UV radiation that, over time, breaks down the substrate leading to yellowing and clouding which reduces headlamp performance. Further, as the UV rays of the sun degrade the substrate, the silica hard-coat may delaminate from the polycarbonate substrate accelerating the substrate degradation. This also leads to degradation of the impact performance of the lens. Still further, the hard-coat process relies upon volatile organic compounds (VOCs) which are an environmental concern.

This document relates to a new and improved method that provides similar or improved scratch resistance and significantly better UV performance than found in current polycarbonate headlamp lenses. As a result, impact resistance and clarity may be better maintained for the life of the vehicle. Further, the method utilized to provide this increased performance is more affordable than and does not release VOCs into the atmosphere like the prior art process.

### SUMMARY

In accordance with the purposes and benefits described herein, a headlamp lens is provided. That headlamp lens comprises a polycarbonate substrate and an infused protective skin covering at least one surface of the polycarbonate substrate.

In one possible embodiment, the infused protective skin includes a scratch-resistant agent and a UV inhibitor. In one possible embodiment, the scratch-resistant agent is silicone-based. In one possible embodiment, the scratch-resistant agent is selected from a group of materials consisting of vinyl (mono-, di- and tri-alkoxysilanes), phenyl (mono-, di- and tri-alkoxysilanes), diphenyldialkoxysilanes, vinyltrialkoxysilanes, and other silicone-based molecules and mixtures thereof.

In one possible embodiment, the UV inhibitor is selected from a group of materials consisting of benzophenone, a benzotriazole and mixtures thereof. Still further, in one possible embodiment, the infused protective skin further includes a UV stabilizer. In one possible embodiment, that UV stabilizer may be a hindered amine light stabilizer.

Still further, the polycarbonate substrate in any embodiment may include a plurality of pores. Further, the scratch-resistant agent may comprise silicon-based molecules having relatively large heads and relatively narrow tails wherein the heads rest on a surface of the substrate overlying the pores and the tails penetrate the pores and act as an anchor for the heads.

In accordance with an additional aspect, a method is provided of manufacturing a polycarbonate headlamp lens with an infused skin providing scratch resistance and UV protection. That method may be described as comprising the steps of molding the headlamp lens substrate from polycarbonate material, cleaning the polycarbonate substrate following molding and infusing a surface of the polycarbonate substrate with a protective skin to produce polycarbonate infused headlamp lenses. This is then followed by rinsing and drying the lenses.

In one possible embodiment, the method further includes increasing the thickness of the protective skin following infusing. In one possible embodiment, this is done by chemically enhanced physical vapor deposition.

In one possible embodiment, the method includes incorporating a scratch resistant agent and a UV inhibitor in the protective skin. That scratch resistant agent may be selected from a group of materials consisting of vinyl (mono-, di- and tri-alkoxysilanes), phenyl (mono-, di- and tri-alkoxysilanes), diphenyldialkoxysilanes, vinyltrimethoxysilanes, other silicone-based molecules and mixtures thereof. Further, the method may include selecting the UV inhibitors from a group of materials consisting of benzophenone, a benzotriazole, other UV inhibitor compounds and mixtures thereof. Further, the method may include incorporating one or more UV stabilizers in the protective skin.

In one possible embodiment, the method includes cooling the headlamp lens substrate after molding and prior to cleaning to a temperature between 65° C. and room temperature. Further, the method includes infusing by dipping the substrate into an infusion tank including an infusion solution bath for a period of time between 10 to 60 seconds at a temperature between 65-90° C. so as to open pores in the substrate to allow superficial infusion of the protective skin to the substrate. In one possible embodiment, the scratch resistant agent and the UV inhibitor are infused in a single step. In another possible embodiment, the scratch resistant agent and the UV inhibitor are infused in multiple steps for the purposes of building up the desired thickness of the hard coating. In addition, the method may include the step of performing a scratch resistance test to select infused lenses and adjusting the concentration of additives in the infusion solution bath as required until the desired results are achieved.

In the following description there are shown and described several preferred embodiments of the headlamp lens. As should be realized, the headlamp lens is capable of other, different embodiments and its several details are capable of modification in various, obvious aspects, all without departing from the headlamp lens as described in the following claims.

Accordingly, the drawings and descriptions should be regarded as illustrative in nature and not as restrictive.

### BRIEF DESCRIPTION OF THE DRAWING FIGURE

The accompanying drawing figure incorporated herein and forming a part of the specification, illustrates several aspects of the infused headlamp lens and together with the description serves to explain certain principles thereof.

FIG. 1 is a schematic representation of the polycarbonate lens with an infused protective coating.

Reference will now be made in detail to the present preferred embodiments of the headlamp lens, an example of which is illustrated in the accompanying drawing figure.

### DETAILED DESCRIPTION

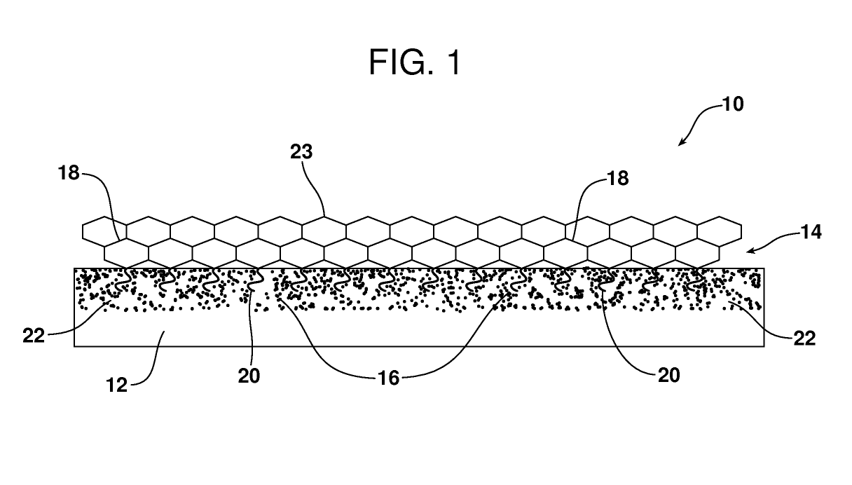

Reference is now made to FIG. 1 illustrating the headlamp lens 10. That headlamp lens 10 comprises a polycarbonate substrate 12 and an infused protective skin 14 covering at least one surface (i.e. the forward surface) of the polycarbonate substrate and an optional PECVD (Plasma Enhanced Chemical Vapor Deposition) build-up.

In one embodiment, the infused protective skin 14 includes a scratch resistance agent and a UV inhibitor. In one possible embodiment, the scratch resistance agent is silicone-based. Such a scratch resistance agent may be selected from a group of materials consisting of vinyl (mono-, di- and tri-alkoxysilanes), phenyl (mono-, di- and tri-alkoxysilanes), diphenyldialkoxysilanes, vinyltrimethoxysilanes, and other silicone-based molecules and mixtures thereof.

In one embodiment the UV inhibitor is selected from a group of materials consisting of a benzophenone, a benzotriazole, or other compounds like hydroxyphenyltriazines and mixtures thereof. Further, in one possible embodiment the infused protective skin further includes one or more UV stabilizers. The UV stabilizer may take the form of a hindered amine light stabilizer.

As illustrated in FIG. 1, in any of the embodiments the polycarbonate substrate 12 includes a plurality of pores 16. In one possible embodiment, the scratch resistance agent comprises silicone-based molecules having relatively large heads 18 and relatively narrow tails 20 wherein the heads rest on a surface of the substrate 12 overlying the pores 16 so as to provide a hard, impact resistant protective coating while the tails 20 penetrate the pores and act as an anchor for the heads. Advantageously, this structure provides a chemical bond between the infused protective skin 14 and the polycarbonate substrate 12 that is (a) far superior to and (b) resists the delamination characteristic of mechanically bonded hard-coats provided on headlamp lenses made in accordance with methods known in the art. It also serves to seal in the UV inhibitor 22 that has penetrated and been deposited deep in other pores 16.

In accordance with an additional aspect, a method is provided for manufacturing a polycarbonate headlamp lens 10 having a polycarbonate substrate 12 and an infused skin 14 providing scratch resistance and UV protection. That method may be broadly described as comprising the steps of molding the headlamp lens substrate 12 from the polycarbonate material, cleaning the polycarbonate substrate following molding, infusing a surface of the polycarbonate substrate with a protective skin 14 and adding an optional PECVD layer 23 to produce an infused headlamp lens 10, rinsing the lens and drying the lens. The method may also include incorporating a scratch resistance agent and a UV inhibitor in the protective skin 14. Further, the method may include selecting a scratch resistance agent from a group of materials consisting of vinyl (mono-, di- and tri-alkoxysilanes), phenyl (mono-, di- and tri-alkoxysilanes), diphenyldialkoxysilanes, vinyltrimethoxysilanes, and other silicone-based molecules and mixtures thereof.

In addition the method may include the selecting of the UV inhibitor from a group of materials consisting of a benzophenone, a benzotriazole, other compounds like hydroxyphenyltriazines and mixtures thereof. Further the method may include incorporating a UV stabilizer in the protective skin 14.

Still more specifically, the method may include cooling the headlamp lens substrate 12 after molding and prior to cleaning to a temperature of between 65° C. and room temperature. Further the infusing step may include dipping the substrate 12 into an infusion tank including an infusion solution bath for a period of time of between 10 to 60 seconds at a temperature between 65-90° C. so as to open the pores 16 in the substrate to allow superficial infusion of the protective skin 14 into the substrate. In one possible embodiment, the scratch resistance agent and the UV inhibitor are infused in a single step. In another possible embodiment, the scratch resistance agent and the UV inhibitor are infused in multiple steps. In another embodiment, the method includes performing a scratch resistance test to selected infused lenses and adjusting the concentrations of additives in the infusion solution bath as required until the desired results are achieved.

Another embodiment is to increase the depth of the silica layer by using an additional deposition process such as PECVD or other deposition process.

In yet another embodiment, the thickness of the infused skin may be further increased by appropriate physical or chemical conditioning or both. A potential way of achieving this is by chemically enhanced physical vapor deposition (CEPVD). In this technique, the infused polycarbonate is placed inside a chamber where silica and related silicon-based compounds (precursors) are ionized and vaporized under partial vacuum at moderate or near ambient temperatures and the vapors are allowed to deposit and condense onto the infused polycarbonate. Final hard coating thicknesses are controlled by the selection of the type of precursor and the chamber time/temperature/vacuum pressure to which the polycarbonate is exposed. In one possible embodiment, the thickness of the infused protection skin is between 1 and 10 microns. In another possible embodiment the protective skin has a thickness of about 7 microns. Where CEPVD is used to increase the thickness of the protective skin, the infused silica surface is receptive to chemical bonding and physical binding with the vaporized silica and related silicon-based compounds to provide a hard, scratch resistant layer.

In one possible embodiment, the polycarbonate headlamp lens substrate may be removed from the molding tool using an overhead conveyor transport. The molded lens may then be cooled to a temperature between 65° C. and room temperature by air circulation or other means prior to cleaning. Cleaning may be completed by dipping the lens 10 into a tank filled with distilled, deionized water for 10 to 30 seconds. That water is maintained at anywhere from room temperature to 65° C.

After cleaning, the lens is dipped into an infusion tank holding an infusion solution bath for from 10 to 60 seconds wherein the bath is held at 65 the 90° C. The bath opens the pores 16 in the surface of the substrate 12 to allow superficial infusion of the additives in the infusion solution to a depth of 0.1-10μ or more as desired.

If the scratch resistance agent and the UV inhibitor are infused in a single step, the infusion solution bath includes an aqueous mixture of surface active agents including ionic and nonionic surfactants (emulsifiers). These surfactants hold two or more immiscible liquids, solids and mixtures in suspension. Proper emulsification is essential to the satisfactory performance of the carrier. Emulsifiers can be ionic (anionic, cationic, and amphoteric) and non-ionic.

Sodium stearate (a soap)—is an example of an anionic surfactant;

Trimethylhexadecyl ammonium bromide—is an example of a cationic surfactant;

Cocoamidopropylbentaine—is an example of an amphoteric surfactant; and

Polyethylene ethoxylate—is an example of a non-ionic surfactant.

Additional chemicals in the infusion solution bath may further include ethanol, other solvents, dispersants, plasticizers and leveling agents. If the scratch resistance agent and the UV inhibitor are infused in a single step, the infusion solution bath may further include hard coating materials based on the hard coating formula and the UV protection formula described below. In the event the scratch resistance agent and the UV inhibitor are to be infused in multiple steps, the first infusion path would include either the hard coating formula or the UV protection formula and a second infusion coating bath would include the other of the hard coating formula or UV protection formula.

For purposes of this document the hard coating formula may be described as comprising a number of silicone-based molecules that are suitable for the hard coating infusion of the polycarbonate lens 12. As previously noted, these may include vinyl (mono-, di- and tri-alkoxysilanes), phenyl (mono-, di- and tri-alkoxysilanes), diphenyldialkoxysilanes, vinyltrimethoxysilane, other silicone-based molecules and mixtures thereof. Such molecules have long chain organic tails 20 that are able to penetrate the polycarbonate pores 16 and act as chemical anchor sites.

For purposes of this document the UV protection formula may be described as including UV absorbers based on conjugated compounds (containing double bonds) that absorb the UV radiation and re-emit it in the lower energy infrared range. These include benzophenones and benzotriazoles. Additionally, the UV protection, may include UV stabilizers. One of the most effective and important stabilizers are the hindered amine light stabilizers (HALS). Rather than simply absorbing the light energy, these stabilizers work by interrupting the photo degradation process before it can get destructively underway. The mechanisms used include “free radical scavenging”, “peroxide decomposition” as well as energy absorption.

With the exception for water and alcohol, concentrations of the various chemicals may range from 0.01% to 10% each by weight or by volume. Concentrations of water and alcohol can range from 10 to 90% by volume.

Rinsing of the lens following infusion may comprise dipping the lens 10 in a second rinse tank of distilled ionized water for 10 to 30 seconds that has a temperature anywhere from room temperature to 65° C. The lens 10 is then removed from the tank and air dried such as by means of a drying fan. After performing any necessary scratch resistance testing on a selected test sample specimen, the remaining lenses 10 in the group of lenses being manufactured together are packaged for shipment. As should be appreciated all the steps may be performed by utilizing a robotic system with precise timing and sequencing protocol. Further, it should be appreciated that the headlamp lenses 10 may be infused at the molding site or at a remote facility any time after molding.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A headlamp lens, comprising:
a polycarbonate substrate; and
an infused protective skin covering at least one surface of said polycarbonate substrate.

2. The lens of claim 1, wherein said infused protective skin includes a scratch resistance agent and a UV inhibitor.

3. The lens of claim 2, wherein said scratch resistance agent is silicone based.

4. The lens of claim 3, wherein said scratch resistance agent is selected from a group of materials consisting of vinyl (mono-, di- and tri-alkoxysilanes), phenyl (mono-, di- and tri-alkoxysilanes), diphenyldialkoxysilanes, vinyltrimethoxysilane, other silicone-based molecules and mixtures thereof.

5. The lens of claim 4, wherein said UV inhibitor is selected from a group of materials consisting of a benzophenone, a benzotriazole, a hydroxyphenyltriazine, and mixtures thereof.

6. The lens of claim 5, wherein said infused protective skin further includes a UV stabilizer.

7. The lens of claim 6, wherein said UV stabilizer is a hindered amine light stabilizer.

8. The lens of claim 3, wherein said polycarbonate substrate includes a plurality of pores.

9. The lens of claim 8, wherein said scratch resistance agent comprises silicone based molecules having relatively large heads and relatively narrow tails wherein said heads rest on a surface of said substrate overlying said pores and said tails penetrate said pores and act as an anchor for said heads.

10. A method of manufacturing a polycarbonate headlamp lens with an infused skin providing scratch resistance and UV protection, comprising:
molding said headlamp lens substrate from polycarbonate material;
cleaning said polycarbonate substrate following molding;
infusing a surface of polycarbonate substrate with a protective skin to produce polycarbonate infused headlamp lens;
rinsing said lens; and
drying said lens.

11. The method of claim 10, further including increasing thickness of said protective skin following infusing.

12. The method of claim 11, including increasing thickness of said protective skin by chemically enhanced physical vapor deposition.

13. The method of claim 11, including incorporating a scratch resistance agent and a UV inhibitor in said protective skin.

14. The method of claim 13, including selecting said scratch resistance agent from a group of materials consisting of vinyl (mono-, di- and tri-alkoxysilanes), phenyl (mono-, di- and tri-alkoxysilanes), diphenyldialkoxysilanes, vinyltrimethoxysilanes, and other silicone-based molecules and mixtures thereof.

15. The method of claim 14, including selecting said UV inhibitors from a group of materials consisting of a benzophenone, a benzotriazole, a hydroxyphenyltriazine, and other UV inhibitor compounds and mixtures thereof.

16. The method of claim 15, including incorporating a UV stabilizer in said protective skin.

17. The method of claim 11, further including cooling said headlamp lens substrate after molding and prior to cleaning to a temperature between 65° C. and room temperature.

18. The method of claim 13, wherein infusing includes dipping said substrate into an infusion tank including an infusion solution bath for a period of time of between 10-60 seconds at a temperature of between 65-90° C. so as to open pores in said substrate to allow superficial infusion of said protective skin into said substrate.

19. The method of claim 18, wherein said scratch resistance agent and said UV inhibitor are infused in (a) a single step or (b) in multiple steps for the purposes of building up the desired thickness of the hard coating.

20. The method of claim 18, including performing a scratch resistance test to selected infused lenses and adjusting concentration of additives in said infusion solution bath as required until desired results are achieved.
